(19) United States
(12) Patent Application Publication
(10) Pub. No.: US 2008/0198108 A1
(43) Pub. Date: Aug. 21, 2008

(54) Array substrate and display unit using it and production method for array substrate

(75) Inventor: Hironori Aoki, Kumamoto (JP)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Mitsubishi Electric Corporation

(21) Appl. No.: 12/011,194

(22) Filed: Jan. 23, 2008

Related U.S. Application Data
(63) Continuation of application No. 10/049,792, filed on Feb. 14, 2002.

(30) Foreign Application Priority Data
Jun. 19, 2000 (JP) 2000-183034

(51) Int. Cl. G09G 3/36

(52) U.S. Cl. 345/87

(57) ABSTRACT

The present invention provides an array substrate in which delay in signal transmission is reduced and provides a display device in which superior display quality is achieved, by using wirings of low resistivity, and moreover, by suppressing increase in wiring resistance caused by contact resistance. A display area in which pixel electrodes (5) are formed, a gate line (2) arranged between the pixel electrodes, a data line (4) crossing over the gate line, a terminal to which a scanning signal for the gate line is applied, an extended scanning line (14), formed from a conductive film of different layer from that for the gate line, for connecting the collected auxiliary capacitance line with the terminal, an auxiliary capacitance line (11) arranged in parallel to the gate line, a collected auxiliary capacitance line (13) arranged in parallel to the signal line and electrically connected to the auxiliary capacitance line, a terminal to which a common signal is applied, and an extended auxiliary capacitance line (15), formed from a conductive film of different layer from that for the collected auxiliary capacitance line, for connecting the collected auxiliary capacitance line with the terminal are formed.

### CROSS REFERENCE TO RELATED APPLICATIONS

This application is a continuation of prior co-pending application Ser. No. 10/049,792, filed Feb. 14, 2002, which is a U.S. National Stage Application under 35 U.S.C. § 371 for International Application No. PCT/JP01/04824 filed Jun. 7, 2001 claiming priority to Japanese Application No. 2000-183034 filed Jun. 19, 2000.

### TECHNICAL FIELD

The present invention relates to an array substrate on which scanning lines and signal lines are formed, a display device equipped with the array substrate, and a manufacturing method for the array substrate.

### BACKGROUND ART

A liquid crystal display device typically comprises two insulative substrates facing each other interposing display material such as liquid crystal therebetween, and voltages are applied selectively to the display material. At least either of the substrates is an array substrate on which switching elements, such as TFTs, and pixel electrodes connected to the switching elements are formed, and furthermore, scanning lines (hereinafter “gate lines”) and signal lines (hereinafter “data lines”) are formed in a matrix like arrangement for providing signals to the switching elements.

Moreover, auxiliary capacitance lines may be formed in order to obtain retaining capacitance between the auxiliary capacitance line and the pixel electrode.

A gate line on an array substrate for the conventional liquid crystal display device is described with referring to FIG. 9. FIG. 9(a) is a plan view of the conventional array substrate showing a terminal of a gate line and part of its display area, and FIG. 9(b) is a sectional view showing the terminal of the gate line taken along line G-G in FIG. 9(a). In FIG. 9, numeral 1 denotes an insulative substrate, 2 denotes a gate line, 3 denotes a gate insulating layer, 4 denotes a data line, 5 denotes a pixel electrode, 9 denotes a passivation film, and 10 denotes a drain electrode of a TFT as a switching element. As shown in FIG. 9, in order to provide signals (scanning signals) externally supplied from a driver IC (not shown) to the liquid crystal panel, a terminal electrode 6 is formed and connected to the gate line 2 directly or via a contact hole 8 in the insulating layers. Although a terminal without a terminal electrode 6 is also possible, wiring material for gate lines 2 and manufacturing process for connecting a driver IC to the terminal would be strictly restricted considering mechanical strength and reliability of the connection, so that deterioration in performance as well as productivity is caused in this case. Therefore, the terminal electrode 6 is usually formed and a transparent conductive film such as ITO (Indium Tin Oxide) is typically used for the terminal electrode 6.

For the case where gate lines are formed with Al and terminal electrodes for the gate lines are formed with ITO, Japanese Unexamined Patent Publication No. 160905/1994 discloses a method to form a pattern of a high melting point metal for connecting the terminal electrode and the gate line. The gate line of low resistivity is extended toward the terminal, and the gate line terminated just before the terminal electrode is electrically connected to the terminal electrode via the high melting point metal.

Meanwhile, for the case where an auxiliary capacitance line is formed in order to obtain retaining capacitance between the auxiliary capacitance line and the pixel electrode, Japanese Unexamined Patent Publication No. 319433/1998 discloses a method to provide a signal to the auxiliary capacitance line. The method will be explained with referring to FIG. 10. FIG. 10(a) is a plan view showing auxiliary capacitance lines, a collected auxiliary capacitance line arranged in parallel to data lines and connected to the auxiliary capacitance lines, an extended auxiliary capacitance line for connecting the collected auxiliary capacitance line to a terminal, and the terminal, while FIG. 10(b) is a sectional view taken along line H-H in FIG. 10(a). In FIG. 10, components as same as those of FIG. 9 are denoted by same numerals, numeral 11 denotes an auxiliary capacitance line, 13 denotes a collected auxiliary capacitance line connected to the all auxiliary capacitance lines 11, 15 denotes an extended auxiliary capacitance line for connecting the collected auxiliary capacitance line 13 and a terminal, 5 denotes a pixel electrode, and 7 denotes a connecting pattern connecting the auxiliary capacitance line 11 and the collected auxiliary capacitance line 13. The auxiliary capacitance lines 11 and the gate lines 2 are formed from the same conductive film, and the auxiliary capacitance lines are electrically connected to the collected auxiliary capacitance line 13, which is formed from the same conductive film for the data lines 4, by the respective connecting pattern 7 formed with transparent conductive film and via the contact hole in the insulating layers. Further, the collected auxiliary capacitance line 13 is extended to the border of the liquid crystal panel via the extended auxiliary capacitance line 15 in the same layer and connected to the terminal electrode 6 via the contact hole 8 in the insulating layers, so that signal terminal for connection to the external circuit is formed.

In case where resistance of such wiring lines formed on the array substrate are increased, signals applied to the switching elements as well as the auxiliary capacitance lines arranged in the display area may be delayed. Such delay may prevent the pixel electrode from attaining a required voltage, so that degradation in display quality such as uneven luminance among the display area may be caused.

The resistance of wiring lines ordinary depends on a resistive component (hereinafter, a drawing resistance) which is determined by material, thickness, width and length of the wiring; and a resistive component (hereinafter, a contact resistance) which is caused by contact of conductive films constituting the wirings. Concerning with the drawing resistance, employment of material having lower resistivity is tried. In case where aluminum (Al) or Al alloy is employed, it can be expected that the resistance is decreased to approximately one fifths as compared with the conventional and typically used wiring material chrome (Cr) of same thickness, width and length.

Concerning with the contact resistance, meanwhile, resistance greatly depends on materials of wirings being in contact and manufacturing process of the array substrate. For example, in case where a wiring of Cr contacts with a transparent conductive film such as ITO or SnO.sub.2 via a contact hole having sides of approximately 50.mu.m, it is relatively easy to keep the contact resistance within several hundreds ohm. However, in case where Al or Al alloy is employed for wiring, it is difficult to reduce the contact resistance between ITO film and the wiring. In case where Al or Al alloy contacts with a transparent conductive film via a contact hole having sides of approximately 50.mu.m, the contact resistance greatly increases to more than several tens kilo-ohm.

As a method to suppress this increase in the contact resistance by way of modification in layout, more contact holes or contact holes of larger diameter is considerable. In order to do so, a region in which contact between them is performed must be enlarged. However, in a region where the terminals are formed, interval between adjacent terminals becomes narrower (for example, interval of about 60.mu.m) in accordance with recent development to obtain finer display, so that area for one terminal tends to decrease. Therefore, although it is advisable that the contact resistance at the terminal region must be suppressed to one-tenth of the wiring resistance, it is difficult and practically impossible to form contact holes of required number or contact hole of required size to achieve this for each terminal region.

In other words, although low resistance material is used as a wiring material attempting to decrease resistance of wiring by reduction in the drawing resistance, resistance of wiring as a whole is increased by increase in the contact resistance. As described above, an area available for this contact is small especially at the terminal region, so that the contact resistance is remarkably increased.

In the above prior arts, however, countermeasure against this increased contact resistance is not satisfactory. Firstly, although contact resistance in which Al or mainly Al metal participates is usually large, contact of Al type metal appears adjacent to the gate terminal electrode in prior art disclosed in Japanese Unexamined Patent Publication No. 160905/1994, so that it is difficult to lower the resistance. Especially in case where conduction between Al and ITO is required from structural reason, contact resistance remarkably increases as described above. In the prior art disclosed in this publication, moreover, the same manner as that of gate lines is shown for connection between auxiliary capacitance line and terminal electrode, thereby, increase in contact resistance occurs at the terminal region. Meanwhile, in case where auxiliary capacitance lines and a collected auxiliary capacitance line, which is connected to all the auxiliary capacitance lines, are formed, and with the construction as disclosed in Japanese Unexamined Patent Publication No. 319433/1998, increase in wiring resistance of the auxiliary capacitance line is caused by contact resistance between material of the auxiliary capacitance line or collected auxiliary capacitance line and transparent conductive film. The auxiliary capacitance lines and the collected auxiliary capacitance line are converted each other at region neighboring the display area as shown in FIG. 1 of this publication. In this case, interval between adjacent gate lines in the display area (for example, about 200.mu.m) determines the area for the conversion, so that area of several times as large as that in terminal region can be kept. Thereby, by increase in number of contact holes or in diameter of a contact hole, it is possible to decrease the resistance compared with contact at the terminal region. However, as a countermeasure against degradation in display quality such as cross talk caused by a signal delay in auxiliary capacitance line under row inverting driving, resistance at the connecting point between the auxiliary capacitance line and the collected auxiliary capacitance line is required to be much lesser than the contact resistance of the gate line. However, above described construction has a problem that it is difficult to reduce the contact resistance between the auxiliary capacitance line and the collected auxiliary capacitance line to the level of several tens ohm which enables to suppress the above described degradation in display quality.

The present invention has been done considering the above problems, and an object of the present invention is to reduce resistance of wiring in which lower resistance is required, and thereby, to provide a display device which shows images of superior quality.

### DISCLOSURE OF INVENTION

The first array substrate according to the present invention is characterized by having a display area in which pixel electrodes are formed, a gate line (scanning line) arranged between the pixel electrodes, a data line (signal line) crossing over the gate line (scanning line) interposing an insulating layer therebetween, a terminal to which a scanning signal is applied, and an extended scanning line formed from a conductive film for connecting the gate line (scanning line) with the terminal, wherein the conductive film for the extended scanning line and that for the scanning line are of different layers.

The second array substrate according to the present invention is characterized by further having an auxiliary capacitance line arranged in parallel to the gate line (scanning line), a collected auxiliary capacitance line arranged in parallel to the data line (signal line) and electrically connected to the auxiliary capacitance line, a terminal to which a common signal is applied, and an extended auxiliary capacitance line formed from a conductive film for connecting the collected auxiliary capacitance line with the terminal for the common signal, wherein the conductive film for the extended auxiliary capacitance line and that for the collected auxiliary capacitance line are of different layers, in the above first array substrate.

The third array substrate according to the present invention is characterized by having a display area in which pixel electrodes are formed, a gate line (scanning line) arranged between the pixel electrodes, an auxiliary capacitance, line arranged in parallel to the gate line (scanning line), a data line (signal line) crossing over the gate line (scanning line) and the auxiliary capacitance line interposing an insulating layer therebetween, a collected auxiliary capacitance line arranged in parallel to the data line (signal line) and electrically connected to the auxiliary capacitance line, a terminal to which a common signal is applied, and an extended auxiliary capacitance line formed from a conductive film for connecting the collected auxiliary capacitance line with the terminal, wherein the conductive film for the extended auxiliary capacitance line and that for the collected auxiliary capacitance line are of different layers.

The forth array substrate according to the present invention is characterized in that the extended scanning line and the data line (signal line) are formed from the conductive film of same layer, in the above first or second array substrate.

The fifth array substrate according to the present invention is characterized in that the extended scanning line and the pixel electrodes are formed from the conductive film of same layer, in the above first or second array substrate.

The sixth array substrate according to the present invention is characterized in that the extended scanning line is electrically connected to the gate line (scanning line) at the neighborhood of the display area and electrically connected to the terminal for the scanning signal at the neighborhood of the terminal, in the above forth or fifth array substrate.

The seventh array substrate according to the present invention is characterized in that the extended auxiliary capacitance line and the data line (signal line) are formed from the conductive film of same layer, in the above second or third array substrate.

The eighth array substrate according to the present invention is characterized in that the extended auxiliary capacitance line and the pixel electrodes are formed from the conductive film of same layer, in the above second or third array substrate.

The ninth array substrate according to the present invention is characterized in that the extended auxiliary capacitance line is electrically connected to the collected auxiliary capacitance line at the neighborhood of the display area and electrically connected to the terminal for the common signal at the neighborhood of the terminal, in the above seventh or eighth array substrate.

The tenth array substrate according to the present invention is characterized in that the auxiliary capacitance line, the corrected auxiliary capacitance line and the scanning line are formed from the conductive film of same layer, in any one of the above second to ninth array substrates.

The eleventh array substrate according to the present invention is characterized in that the collected auxiliary capacitance line and the extended scanning line are crossing interposing a insulating layer therebetween, in any one of the above second, fourth to tenth array substrates.

The twelfth array substrate according to the present invention is characterized in that aluminum or aluminum alloy is used for material of the gate line (scanning line), in any one of the above first to eleventh array substrates.

The thirteenth array substrate according to the present invention is characterized in that partly or wholly nitridated aluminum or partly or wholly nitridated aluminum alloy is used for material of the gate line (scanning line), in any one of the above first to eleventh array substrates.

The fourteenth array substrate according to the present invention is characterized in that high melting point metal such as Cr or Mo is used for material of the data line (signal line), in any one of the above first to thirteenth array substrates.

The fifteenth array substrate according to the present invention is characterized in that the gate line (scanning line) and the extended-scanning line are electrically connected via a-conductive-film of the same layer as that for the pixel electrode, in any one of the above first, second, fourth to fourteenth array substrates.

The sixteenth array substrate according to the present invention is characterized in that the collected auxiliary capacitance, line and the extended auxiliary capacitance line are electrically connected-via a conductive film of the same layer as that for then pixel electrode, in any one of the above second to fifteenth array substrates.

The seventeenth array substrate according to the present invention is characterized in that either of the gate line (scanning line) or the extended scanning line is formed in a grid or ladder like shape at a region in which the gate line (scanning line) and the extended scanning line are overlapped within a connecting portion between the gate line (scanning line) and the extended scanning line, in any one of the above first, second, fourth to sixteenth array substrates.

The eighteenth array substrate according to the present invention is characterized in that either of the collected auxiliary capacitance line or the extended auxiliary capacitance line is formed in a grid or ladder like shape at a region in which the collected auxiliary capacitance line and the extended auxiliary capacitance line are overlapped within a connecting portion between the collected auxiliary capacitance line and the extended auxiliary capacitance line, in any one of the above second to seventeenth array substrates.

The first display device according to the present invention is characterized in that liquid crystal is interposed between any one of the above first to eighteenth array substrate and a counter substrate having a common electrode and a color filter.

The first manufacturing method for an array substrate according to the present invention is characterized by having a step of depositing a conductive film and forming a gate line (scanning line) which is arranged between pixel electrodes, a step of depositing a conductive film of another layer of the gate line (scanning line) and forming a extended scanning line for connecting the gate line (scanning line) with a terminal to which scanning signal is applied, and a step of forming a insulating film which is arranged between the gate line (scanning line) and the extended scanning line and insulates the scanning line from the extended scanning line.

The second manufacturing method for an array substrate according to the present invention is characterized by having a step of depositing a conductive film and forming a gate line (scanning line) arranged between pixel electrodes, an auxiliary capacitance line arranged in parallel to the gate line (scanning line) and a collected auxiliary capacitance line connected to the auxiliary capacitance line, a step of depositing a conductive film of another layer of the gate line (scanning line), the auxiliary capacitance line and the collected auxiliary capacitance line and forming a extended auxiliary capacitance line for connecting the collected auxiliary capacitance line with a terminal to which common signal is applied, and a step of forming a insulating film which is arranged between the extended auxiliary capacitance line and the gate line (scanning line), the auxiliary capacitance line or the extended scanning line and insulates the extended auxiliary capacitance line from the gate line (scanning line), the auxiliary capacitance line and the collected auxiliary capacitance line.

### BRIEF DESCRIPTION OF THE DRAWINGS

FIG. 1 is a drawing of electrode section of an extended scanning line (gate line) in an embodiment 1 of the present invention;

FIG. 2 is a drawing of section connecting a gate line and an extended scanning line near display area in an embodiment 1 of the present invention;

FIG. 3 is a drawing of electrode section of an extended auxiliary capacitance line (auxiliary capacitance line) in an embodiment 2 of the present invention;

FIG. 4 is a drawing of section connecting a collected auxiliary capacitance line and an extended auxiliary capacitance line near display area in an embodiment 2 of the present invention;

FIG. 5 is an explanatory view of an embodiment 3 in the present invention;

FIG. 6 is an explanatory view of an embodiment 4 in the present invention;

FIG. 7 is a drawing of connecting section of a gate line and an extended scanning line in an embodiment 5 of the present invention;

FIG. 8 is a drawing of connecting section of a gate line and an extended scanning line in an embodiment 5 of the present invention;

FIG. 9 is a drawing of electrode and display area in the conventional array substrate; and

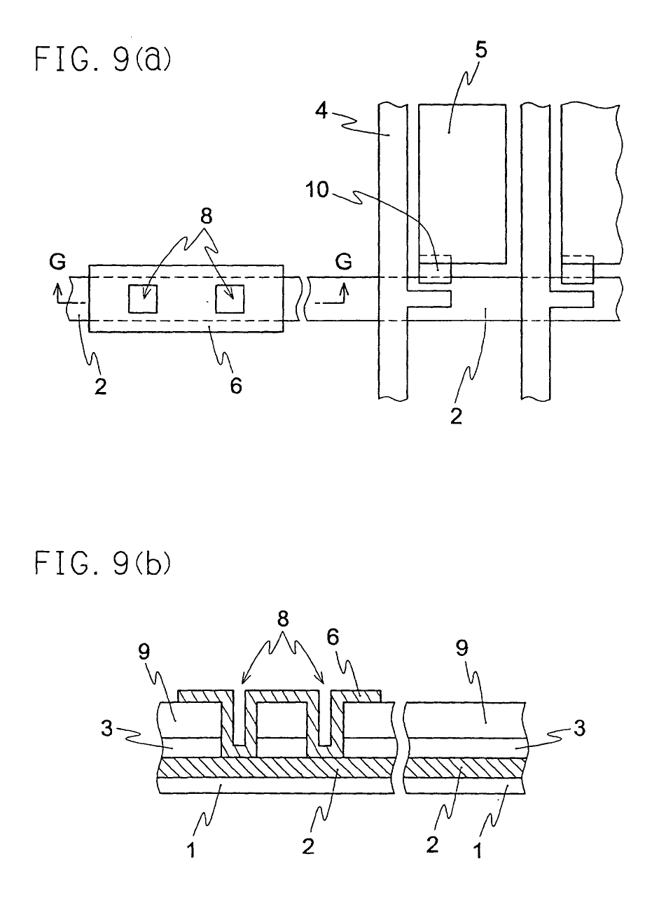

FIG. 10 is a plan view of an auxiliary capacitance line, a collected auxiliary capacitance line, an extended auxiliary capacitance line and an electrode section in the conventional array substrate.

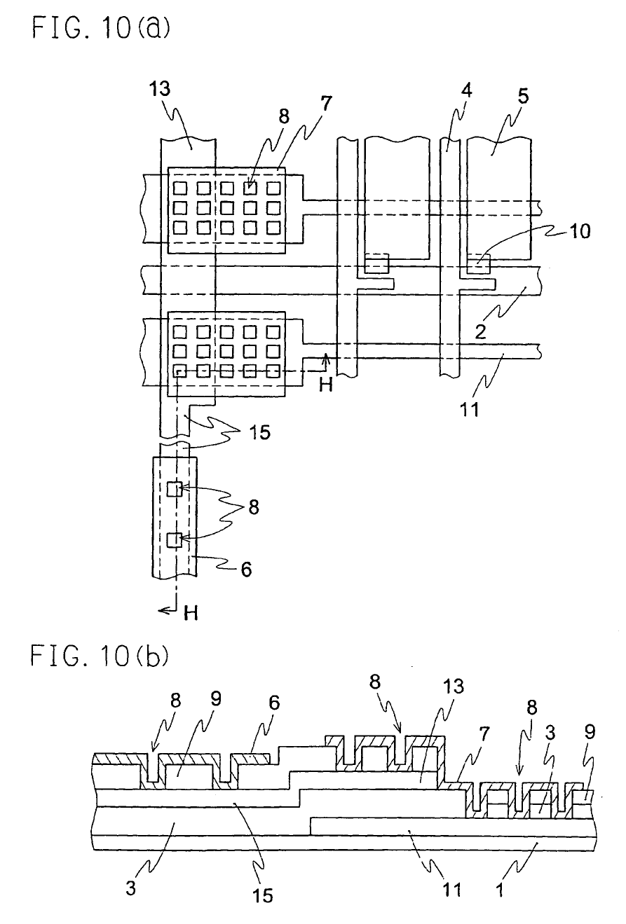

### BEST MODE FOR CARRYING OUT THE INVENTION

### Embodiment 1

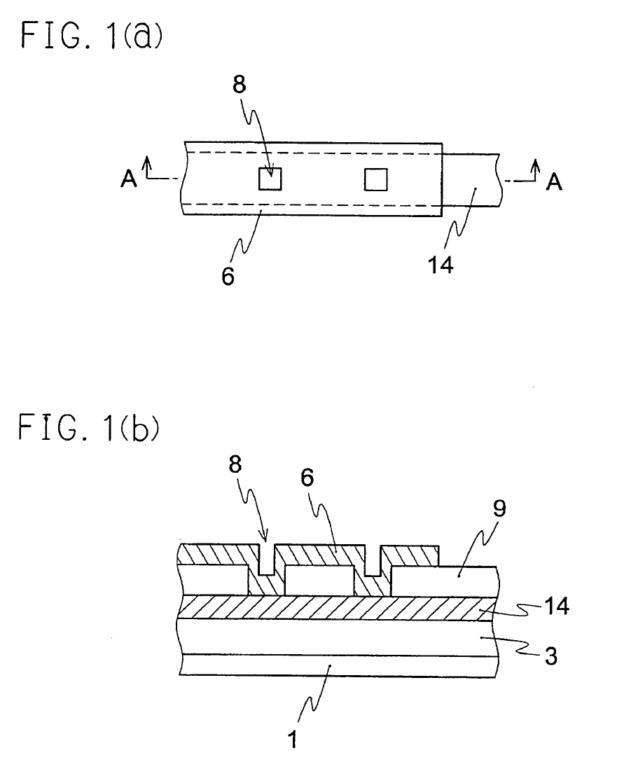

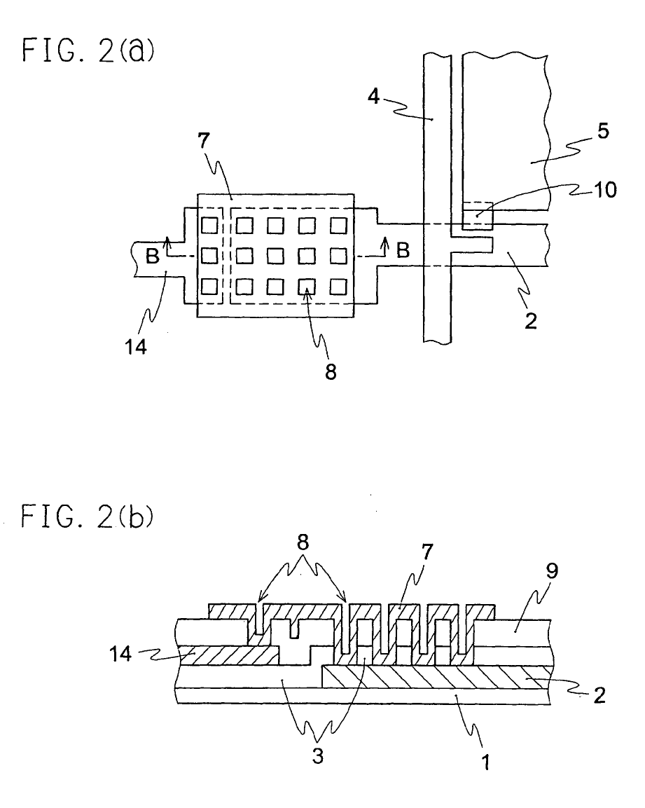

FIGS. 1 and 2 are drawings showing the structure of array substrate in Embodiment 1 of the present invention. FIG. 1(a) shows a plan view of the electrode section of an extended scanning line (gate line), and FIG. 1(b) shows a cross sectional view taken along line A-A in the FIG. 1(a). FIG. 2(a) shows a plan view of the region around the section connecting the gate line and the extended scanning line near display area where pixel electrode is formed, and FIG. 2(b) shows a cross sectional view taken along line B-B in the FIG. 2(a).

In the Figures, numeral 1 denotes an insulative substrate, 2 denotes a gate line (a scan line), 3 denotes a first insulating layer (gate insulating layer), 4 denotes a data line, 5 denotes a pixel electrode, 6 denotes a terminal electrode, 7 denotes a connecting pattern connecting the gate line 2 to the extended scanning line 14, 8 denotes a contact hole formed through the first insulating layer or the first and second insulating layer, 9 denotes a second insulating layer (a passivation layer), 14 denotes an extended gate line formed in the same manufacturing step with the data line, respectively. As is in FIG. 1, a signal for scanning the pixel (i.e. a scanning signal) is input from a driver IC (not described in the figure), which operates as an external signal source, to gate line 2, through the terminal electrode 6 in terminal region of the extended scanning line 14.

Hereinafter, a process for fabricating an array substrate according to Embodiment 1 of the present invention is described. At first, a first conductive layer is formed on an insulative substrate 1. As the conductive layer, for example, thin films made of Al, Cr, Copper (Cu), Tantalum (Ta), Molybdenum (Mo) or alloys of these materials in which other element(s) are added are used. Electrical resistivity of the first conductive layer is preferably as small as possible, because it is used for a gate line 2 as described later. Next, with the first photolithography process, the gate line 2 is formed by patterning the first conductive layer. Here, connecting portion connecting the gate line 2 and an extended scanning line 14 is formed as large as possible, as long as it is not electrically connected to adjacent pattern. And, in some part on the first conductive layer, a contact hole 8 is formed through the insulating layer by dry-etching process as described later, and the conductive layers contact each other through the contact hole 8.

Next, using film deposition apparatus such as plasma CVD equipment, a first insulating layer (gate insulating layer) 3, a semiconductor layer (not described), an ohmic-contacting layer (not described) are deposited in series. As the first insulating layer for gate insulating layer, SiNx, SiOx, SiOxNy, or the multilayer of these materials are used. As the semiconductor layer, amorphous silicon (i-a-Si) or polycrystalline silicon (i-p-Si) is used. Further, as the ohmic-contacting layer, amorphous silicon or polycrystalline silicon with small amount of dopant such as phosphor (n-a-Si or n-p-Si) is used. Then, with the second photolithography process, the semiconductor layer and the ohmic-contacting layer are etched by process such as dry-etching.

Next, a second conductive layer is deposited. As the second conductive layer, Cr, Mo, Ta, Al, the thin films comprising alloy where other materials are doped to these elements, layer where different metal films are stacked, or layer where composition varies in thickness direction may be used. The second conductive layer is partly covered with a third conductive layer by the process described later, and in order to obtain electric contact therebetween, the second conductive layer should have low contact resistance at least in the region contacting to the third conductive layer. For example, when ITO is used as the third conductive layer, the region contacting to the third conductive layer may preferably consist of Cr or Mo. After that, with the thirds photolithography process, the second conductive layer is patterned to form a data, line 4, a drain electrode 10, and the extended scanning line 14 ranges from near display area to near terminal electrode region. Near the display area and near the terminal region, the extended scanning line 14 has a structure where it conducts to the third conductive layer as described later.

Then, a second insulating layer 9 (passivation layer) is deposited by the film deposition apparatus such as plasma CVD equipment. And, using the fourth photolithography process and an etching process, a contact hole 8 is formed in the first insulating layer or the first and second insulating layers. At this time, in region near the display area where connection to the gate line is made, contact holes with larger number or contact hole with larger contact area may be formed compared with region near the gate terminal. Then, the third conductive layer is deposited by methods such as sputtering. As the third conductive layer, transparent conducting film such as ITO is used for transmissive type display device, and opaque metal film such as Cr is used for reflective type display device. By performing a photolithography and etching process for the third conductive layer, a connecting pattern 7 which connects the gate line 2 and the extended scanning line 14, the terminal electrode 6 and the pixel electrode 5 are formed. Through this connecting pattern, the gate line 2 and the extended scanning line 14 are electrically connected near display area.

As described above, according to this embodiment, an increase in wiring resistance, which is observed in a conventional case where gate line is made of material showing increased contact resistance at terminal electrode, can be suppressed, and array substrate can be obtained where delay in scanning signal applied to switching device formed in the display area is reduced. Therefore, by using the array substrate of the present embodiment, in LCD device where liquid crystal is provided between the array substrate and the counter substrate with at least common electrode and color filter, unevenness originated from the delay in scanning signal can be suppressed and display device with excellent quality can be obtained.

And, in the present embodiment, since the extended scanning line is made of an different layer (the second conductive layer in the present embodiment) from gate line (the first conductive layer in the present embodiment), an effect of increase of contact resistance to ITO which occurs in the case where Al or Al alloys is used as gate line, can be further suppressed by having a large area contact near display area, and wire resistance can be further reduced.

Further, for a case where gate line is made of Al or Al alloys, an increase of contact resistance due to growth of surface oxidation in following process can be reduced by nitridation of the surface of the gate line.

Further, the structure in the present embodiment is not limited to either the array substrate with auxiliary capacitance line or the array substrate of Cs on-gate type where auxiliary capacitance line is not used but auxiliary capacity formed between next gate line and pixel electrode is used, and is applicable to every kind of display device driven by gate line. For example, it may be applied to the common line in the passive type display device.

And, in the above embodiment, although the extended scanning line is formed by different process from either for terminal electrode, pixel electrode or gate line, the extended scanning line may be formed by the same process as the terminal electrode or pixel electrode as long as the increase in resistance of the extended scanning line is within allowable range. In this case, gate line and extended scanning line may be contacted through the contact hole formed in the insulating layer, or may be directly contacted without contact hole. For both cases, similar effect as described before can be obtained by increasing the number of the contact hole or providing large area of the contact hole near display area.

### Embodiment 2

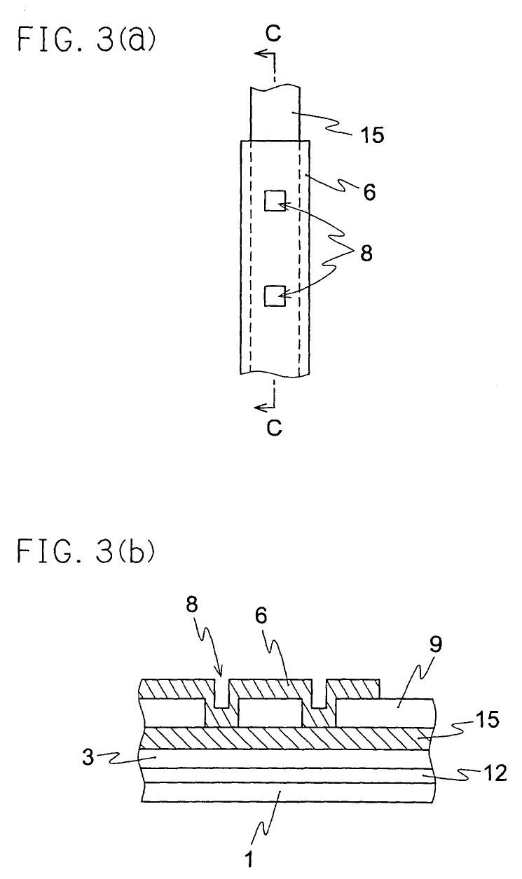

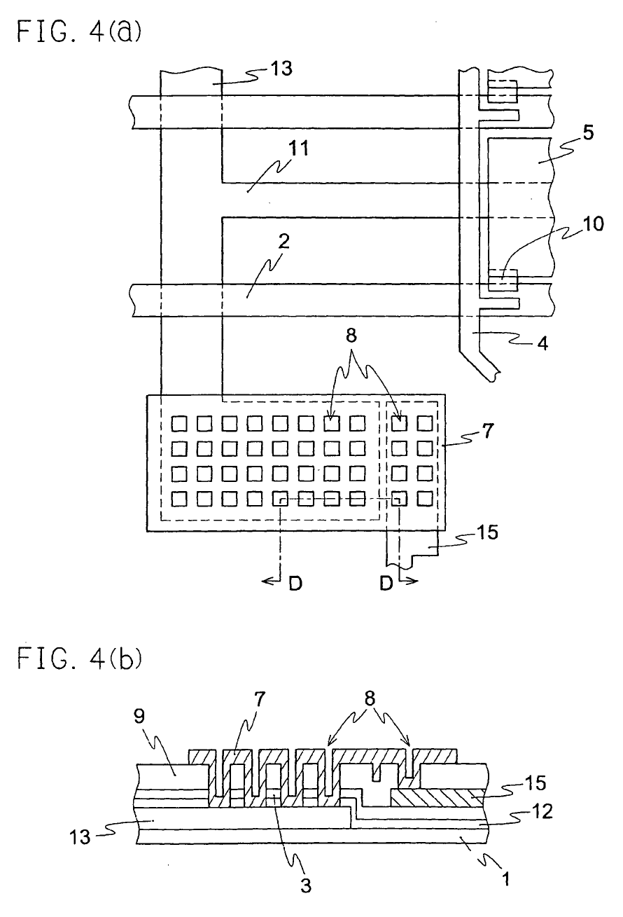

FIGS. 3 and 4 are drawings showing the structure of array substrate in Embodiment 2 of the present invention. FIG. 3(a) shows a plan view of the electrode section of an extended auxiliary capacitance line (auxiliary capacitance line), and FIG. 3(b) shows a cross sectional view taken along-line C-C in the FIG. 3(a). FIG. 4(a) shows a plan view of the section connecting the auxiliary capacitance line and the extended auxiliary capacitance line near display area, and FIG. 4(b) shows a cross sectional view taken along line D-D in the FIG. 4(a).

In the Figures, same numerals denote same parts as the embodiment 1, and 11 denotes an auxiliary capacitance line, 12 denotes an insulating layer for auxiliary capacitance, 13 denotes collected auxiliary capacitance line connecting the all auxiliary capacitance lines 11, 15 denotes an extended auxiliary capacitance line which is formed in identical process with the data line 4, 8 denotes a contact hole provided in the first to the third insulating layers, 9 denotes the third insulating layer (passivation layer), respectively. As in the FIG. 3, signal (common signal) is input from a driver IC (not described in the figure), which operates as an external signal source, to the auxiliary capacitance line 11, the collected auxiliary capacitance line 13 and the extended auxiliary capacitance line 15, through the terminal electrode 6 at the terminal region of the extended auxiliary capacitance line 15.

Below, a process for fabricating an array substrate according to Embodiment 2 of the present invention is described. At first, a first conductive layer is formed on an insulative substrate 1. As the conductive layer, for example, thin films made of Al, Cr, Cu, Ta, Mo or alloys in which other element(s) are added to these are used. Electrical resistivity of the first conductive layer is preferably as small as possible, because it is used for the auxiliary capacitance line 11 or the collected auxiliary capacitance line 13. Next, using the first photolithography process, the auxiliary capacitance line 11 and the collected auxiliary capacitance line 13 are formed by patterning the first conductive layer. Here, at the connecting region to the extended auxiliary capacitance line 15, the area of the collected auxiliary capacitance line 13 is formed as large as possible so as to decrease contact resistance at the connecting region, as long as it is not electrically connected to the next pattern. And, on some part of the first conductive layer, a contact hole 8 is formed in the insulating layer by dry-etching process as described later and the conductive layer is contacted through the contact hole 8.

Next, using film deposition apparatus such as plasma CVD equipment, the insulating layer 12 for forming auxiliary capacitance is deposited and then the second conductive layer is deposited. As the second conductive layer, Cr, Mo, Ta, the thin films comprising alloy where other materials are added to these elements, layer with different metal films stacked, or layer where, composition varies in thickness direction may be used. Next, with the second photolithography process, said second conductive layer is patterned to form the gate line 2. Further, a gate insulating layer 3, a semiconductor layer (not described in the figure), and an ohmic-contacting layer (not described) are deposited in series. As the gate insulating layer, SiNx, SiOx, SiOxNy, or the multilayer of these materials is used. As the semiconductor layer, amorphous silicon (i-a-Si) or polycrystalline silicon (i-p-Si) is used. Further, as the ohmic-contacting layer, amorphous silicon or polycrystalline silicon with small amount of dopant such as phosphor, (n-a-Si, n-p-Si) is used. Then, with the third photolithography process, the semiconductor layer and the ohmic-contacting layer are etched by using dry-etching process.

Next, the third conductive layer is deposited. As the third conductive layer, Cr, Mo, Ta, Al, the thin films comprising alloy where other materials are added to these elements, layer with different metal films stacked, or layer where composition varies in thickness direction may be used. The third conductive layer is partly covered with the fourth conductive layer, and in order to obtain electrical contact, the third conductive layer should have low contact resistance at least in the region contacting to the fourth conductive layer. For example, when ITO is used as the fourth conductive layer, the region contacting to the third conductive layer may preferably consist of refractory metal such as Cr or Mo. After that, with the fourth photolithography process, said third conductive layer is patterned to form the data line 4, the drain electrode 10, and the extended auxiliary capacitance line 15 ranging from near display area to near terminal electrode region. Near display area and near terminal region, the extended auxiliary capacitance line 15 has a structure where it conducts through the fourth conductive layer.

Then, the insulating layer for passivation film is deposited by the film deposition apparatus such as plasma CVD equipment. Then, with the fifth photolithography and etching process, a contact hole 8 is formed in the insulating layer 12 for the auxiliary capacitance, the gate insulating layer 3 and the passivation layer 9. At this time, in the collected auxiliary capacitance line 13 near the display area, contact holes with large numbers as many as possible or larger contact area are provided. Then, the fourth conductive layer is deposited by methods such as sputtering. As the fourth conductive layer, transparent conducting films such as ITO are, used for transmissive type display, and opaque metal films such as Cr are used for reflective type display. By performing photolithography and etching for this fourth conductive layer, the connecting pattern 7, the terminal electrode 6 and the pixel electrode 5 are formed. Through this connecting pattern, the collected auxiliary capacitance line 13 and the extended auxiliary capacitance line 15 are electrically connected near display area.

As described above, according to this embodiment, resistance formed between the auxiliary capacitance line and the collected auxiliary capacitance line, which is observed in conventional structure, can be eliminated since the auxiliary capacitance line and the collected auxiliary capacitance line are fabricated in the same process and contact resistance at the terminal region, where the extended auxiliary capacitance line and the terminal electrode contact, can be decreased. Therefore, array substrate where delay in common signal is reduced can be obtained.

And, by using the array substrate of the present embodiment, in LCD device where liquid crystal is provided between said array substrate and counter substrate with at least common electrode and a color filter, unevenness originated from the delay in common signal can be suppressed and display device with excellent quality can be obtained.

Further, in the present embodiment, since the extended auxiliary capacitance line is made of an different layer (the third conductive layer in the present embodiment) from the auxiliary capacitance line and the collected auxiliary capacitance line (the first conductive layer in the present embodiment), an effect of increase of contact resistance to ITO which occurs in the case where Al or Al alloys is used for the auxiliary capacitance line and the collected auxiliary capacitance line, can be further suppressed by having a large contact area near the display area, and wiring resistance can be further reduced.

Further, for a case where the auxiliary capacitance line, and the collected auxiliary capacitance line is made of Al or Al alloys, an increase of contact resistance due to growth of surface oxidation in following process can be reduced by nitrization of the surface of the lines.

And, in the above embodiment, although the extended auxiliary capacitance line is formed by different process from either for terminal electrode, pixel electrode or the collected auxiliary capacitance line, extended auxiliary capacitance line may be formed by the same process as for the terminal electrode or pixel electrode as long as the increase in resistance of the extended auxiliary capacitance line is within allowable range, which is similar to the embodiment 1.

### Embodiment 3

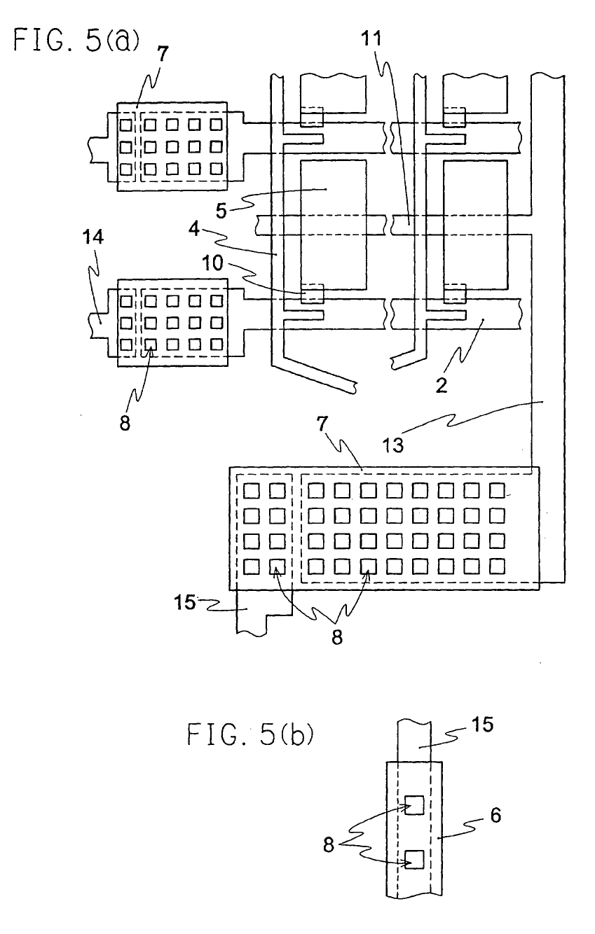

FIG. 5 shows the structure of array substrate in an embodiment 3 of the present invention. FIG. 5(a) is a plan view showing a region near the display area in which connection between the collected auxiliary capacitance line and the extended auxiliary capacitance line is made, while FIG. 5(b) is a plan view showing a region in which terminal for the extended auxiliary capacitance line is formed. As shown in FIG. 5(b), via the terminal electrode 6 at the terminal region of the extended auxiliary capacitance line 15, a common signal is applied to the auxiliary capacitance line 11 from the driver IC (not shown) as an external signal source.

Hereinafter, a manufacturing method for array substrate according to the embodiment 3 of the present invention will be described. Firstly, a first conductive layer is formed on an insulative substrate. For the first conductive layer, a thin film made of Al, Cr, Cu, Ta, Mo or alloy of these materials in which other material(s) are added is used. As described in later, since the gate line 2, the auxiliary capacitance line 11 and the collected auxiliary capacitance line 13 are formed from the first conductive layer, lower resistivity is required for the first conductive layer. By patterning the first conductive layer through the first photolithography process, the gate line 2, the auxiliary capacitance line 11 and the collected auxiliary capacitance line 13 are formed. In the present Embodiment, an example in which the collected auxiliary capacitance line 13 is formed in a side where the extended scanning line 14 for the gate line 2 is not formed. In a region near the display area, the gate line 2 is formed to have a larger area for connection with the extended scanning line 14, but not to contact with the adjacent patterns. In a region near the display area, the collected auxiliary capacitance line 13 is formed to have a larger area, which allows to reduce contact resistance at the connecting portion with the extended-auxiliary capacitance line 15, but not to contact with the adjacent patterns. At the some part on the first conductive layer, as will be described in below, contact holes 8 through a insulating layer are formed by a dry etching process and conductive films contact each other through the contact holes 8.

The first insulating layer, a semiconductor layer (not shown) and an ohmic-contacting layer (not shown) are sequentially formed using a film deposition apparatus such as plasma CVD equipment. For the first insulating layer, which is used as a gate insulating layer, SiNx, SiOx, or SiOxNy is employed. A multilayer of these materials is also applicable. For the semiconductor layer, amorphous silicon (i-a-Si) or polycrystalline silicon (i-p-Si) is used. Further, for the ohmic contacting layer, amorphous silicon or polycrystalline silicon with small amount of dopant such as phosphor (n-a-Si or n-p-Si) is used. Then, through the second photolithography process, the semiconductor layer and the ohmic-contacting layer are etched by process such as dry etching.

Thereafter, a second conductive layer is formed. As the second conductive layer, Cr, Mo, Ta, Al, the thin films comprising alloy where other materials are doped to these elements, layer where different metal films are stacked, or layer where composition varies in thickness direction may be used. The second conductive layer is partly covered with the third conductive layer by the process described later, and in order to obtain electric contact therebetween, the second conductive layer should have low contact resistance at least in the region contacting to the third conductive layer. For example, when ITO is used as the third conductive layer, the region contacting to the third conductive layer may preferably comprises high melting point metal such as Cr or Mo. After that, with the third photolithography process, the second conductive layer is patterned to form the data line 4, a drain electrode 10, the extended scanning line 14 and the extended auxiliary capacitance line 15, the extended scanning line 14 and the extended auxiliary capacitance line 15 range from near display area to near respective terminal electrode region. The extended scanning line and the extended auxiliary capacitance line 15 are electrically connected to the gate line 2 and the collected auxiliary capacitance line 13 respectively at the region near the display area via a third conductive layer described latter, and electrically connected to the respective terminal electrode 6 at the region near the terminal via a third conductive layer described latter.

Preceding to the third conductive layer, a second insulating layer (not shown), which constitutes a passivation film, is formed using a film deposition apparatus such as plasma CVD equipment. Thereafter, through processes such as a forth photolithography and a dry etching succeeding thereto, contact holes 8 through the first insulating layer or through the first and second insulating layer are formed. At this time, on the gate line 2 near the display area and on the collected auxiliary capacitance line 13 near the display area, contact holes as many as possible and/or a contact hole as large as possible are formed. Then, the third conductive layer is formed by a method such as sputtering. As the third conductive layer, transparent conductive film such as ITO is used for transmissive type display device, and opaque metal film such as Cr is used for reflective type display device. Subjecting the third conductive layer to a photolithography and succeeding etching process, the connecting patterns 7, the terminal electrodes 6 and the pixel electrode 5 are formed. Via the connecting pattern 7 thus formed, the gate line 2 and the extended scanning line 14 are electrically connected at the region near the display area. Similarly, the collected auxiliary capacitance line 13 and the extended auxiliary capacitance line 15 are electrically connected by the connecting pattern 7 at the region near the display area.

According to the present embodiment as described above, in addition to the advantage of the above embodiment 2, that is, enhanced display quality in which unevenness caused by delay in common signal is suppressed, unevenness in displayed image caused by delay in gate signals is also suppressed similar to the above embodiment 1. Furthermore, the auxiliary capacitance line, the collected auxiliary capacitance line and the gate line are formed in a same manufacturing step, so that increase in productivity is also achieved.

By using an array substrate according to the present embodiment and sandwiching liquid crystal with a counter substrate on which at least a common electrode and color filter are provided, a display device of superior image, in which unevenness caused by delay in gate signals as well as unevenness caused by delay in common signal are suppressed, is obtained.

Moreover, the extended scanning line and the extended auxiliary capacitance line are formed neither in manufacturing step for the terminal and pixel electrodes nor in manufacturing step for the collected auxiliary capacitance line. However, if increase in resistance of the extended scanning line or the extended auxiliary capacitance line falls within an acceptable value, either of or both of them may be formed through the step for the terminal and pixel electrodes.

### Embodiment 4

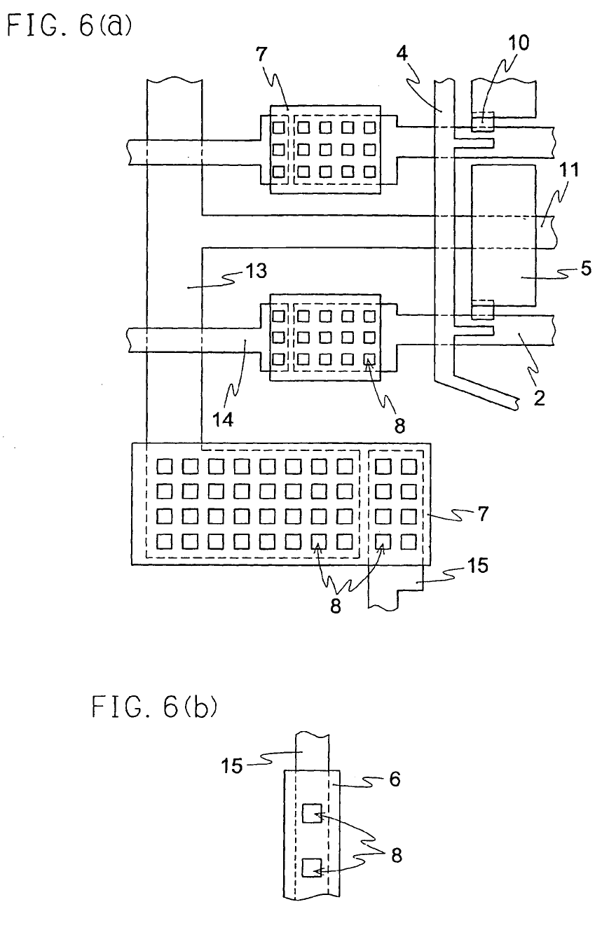

FIG. 6 shows the structure of array substrate in an embodiment 4 of the present invention. FIG. 6(a) is a plan view showing a region near the display area in which connection between the collected auxiliary capacitance line and the extended auxiliary capacitance line is made, while FIG. 6(b) is a plan view showing a region in which terminal for the extended auxiliary capacitance line is formed. As shown in FIG. 6(b), via the terminal electrode 6 at the terminal region of the extended auxiliary capacitance line 15, a common signal is applied to the auxiliary capacitance line 11 from the driver IC (not shown) as an external signal source.

Hereinafter, a manufacturing method for array substrate according to the embodiment 4 of the present invention will be described. Firstly, a first conductive layer is formed on an insulative substrate. For the first conductive layer, a thin film made of Al, Cr, Cu, Ta, Mo or alloy of these materials in which other material(s) are added is used. As described in later, since the gate line 2, the auxiliary capacitance line 11 and the collected auxiliary capacitance line 13 are formed from the first conductive layer, lower resistivity is required for the first conductive layer. By patterning the first conductive layer through the first photolithography process, the gate line 2, the auxiliary capacitance line 11 and the collected auxiliary capacitance line 13 are formed. In the present Embodiment, an example in which the collected auxiliary capacitance line 13 is formed in a side where the extended scanning line 14 for the gate line 2 is formed. In a region near the display area; the gate line 2 is extended within a range not to contact with the collected auxiliary capacitance line 13 and preferably formed to have a larger but limited area not to contact with the adjacent patterns. The collected auxiliary capacitance line 13 is formed to have a larger area, which allows to reduce contact resistance at the connecting portion with the extended auxiliary capacitance line 15, but not to contact with the adjacent patterns. At the some part on the first conductive layer, as will be described in below, contact holes 8 through a insulating layer are formed by a dry etching process and conductive films contact each other through the contact holes 8.

The first insulating layer, a semiconductor layer (not shown) and an ohmic-contacting layer (not shown) are sequentially formed using a film deposition apparatus such as plasma CVD equipment. For the first insulating layer, which is used as a gate insulating layer, SiNx, SiOx, or SiOxNy is employed. A multilayer of these materials is also applicable. For the semiconductor layer, amorphous silicon (i-a-Si) or polycrystalline silicon (i-p-Si) is used. Further, for the ohmic-contacting layer, amorphous silicon or polycrystalline silicon with small amount of dopant such as phosphor (n-a-Si or n-p-Si) is used. Then, through the second photolithography process, the semiconductor layer and the ohmic-contacting layer are etched by process such as dry etching. Thereafter, a second conductive layer is formed. As the second conductive layer, Cr, Mo, Ta, Al, the thin films comprising alloy where other materials are doped to these elements, layer where different metal films are stacked, or layer where composition varies in thickness direction may be used. The second conductive layer is partly covered with the third conductive layer by the process described later, and in order to obtain electric contact therebetween, the second conductive layer should have low contact resistance at least in the region contacting to the third conductive layer. For example, when ITO is used as the third conductive layer, high melting point metal such as Cr or Mo is preferable for the second conductive layer. After that, with the third photolithography process, the second conductive layer is patterned to form the data line 4, a drain electrode 10, the extended scanning line 14 and the extended auxiliary capacitance line 15, the extended scanning line 14 and the extended auxiliary capacitance line 15 range from near display area to near respective terminal electrode region. The extended auxiliary capacitance line 15 is electrically connected to a third conductive layer described latter at the region near the display area and at the region near the terminal.

Preceding to the third conductive layer, a second insulating layer (not shown), which constitutes a passivation film, is formed using a film deposition apparatus such as plasma CVD equipment. Thereafter, through processes such as a forth photolithography and a dry etching succeeding thereto, contact holes 8 through the first insulating layer or through the first and second insulating layer are formed. At this time, on the gate line 2 near the display area and on the collected auxiliary capacitance line 13 near the display area, contact holes as many as possible and/or a contact hole as large as possible are formed. Then, the third conductive layer is formed by a method such as sputtering. As the third conductive layer, transparent conductive film such as ITO is used for transmissive type display device, and opaque metal film such as Cr is used for reflective type display device. Subjecting the third conductive layer to a photolithography and succeeding etching process, the connecting patterns 7, the terminal electrodes 6 and the pixel electrode 5 are formed. Via the connecting pattern 7 thus formed, the gate line 2 and the extended scanning line 14 are electrically connected at the region near the display area. Similarly, the collected auxiliary capacitance line 13 and the extended auxiliary capacitance line 15 are electrically connected by the connecting pattern 7 at the region near the display area.

According to the present embodiment as described above, in addition to the advantages of the above embodiment 3, the collected auxiliary capacitance line and the extended auxiliary capacitance line can be formed even in a side where the extended scanning line for the gate line toward the terminal is formed. Of course, another collected auxiliary capacitance line and another extended auxiliary capacitance line (not shown) may be formed in a side where no extended scanning line is formed to obtain another signal path for transmitting a signal to the auxiliary capacitance lines in the display area. Thereby, delay in common signal applied to the auxiliary capacitance line is further decreased.

By using an array substrate according to the present embodiment and sandwiching liquid crystal with a counter substrate on which at least a common electrode and a color filter are provided, a display device of superior image, in which unevenness caused by delay in gate signals is suppressed and unevenness caused by delay in common signal is further suppressed, is obtained.

Moreover, the extended scanning line and the extended auxiliary capacitance line are formed neither in manufacturing step for the terminal and pixel electrodes nor in manufacturing step for the collected auxiliary capacitance line. However, if increase in resistance of the extended scanning line or the extended auxiliary capacitance line falls within an acceptable value, either of or both of them may be formed through the step for the terminal and pixel electrodes.

### Embodiment 5

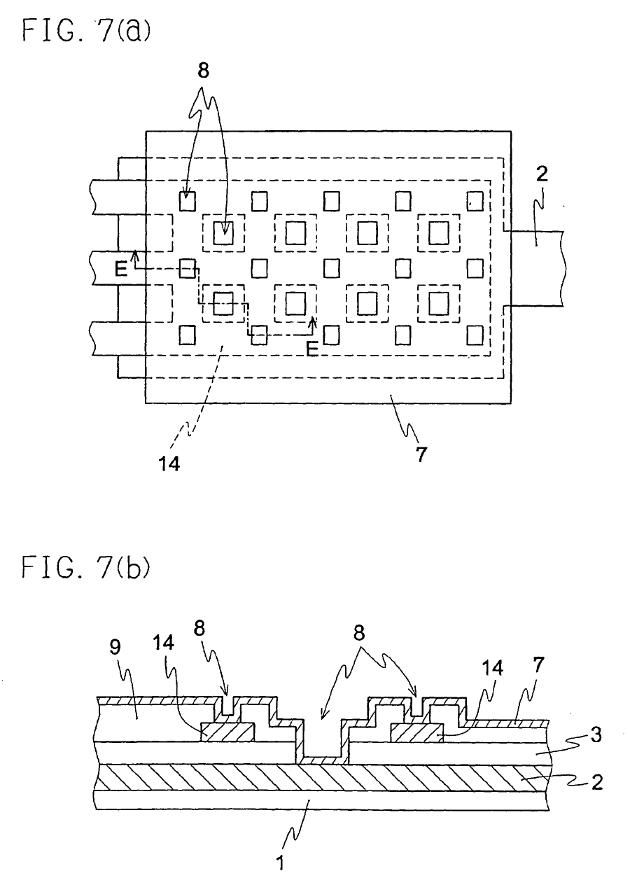

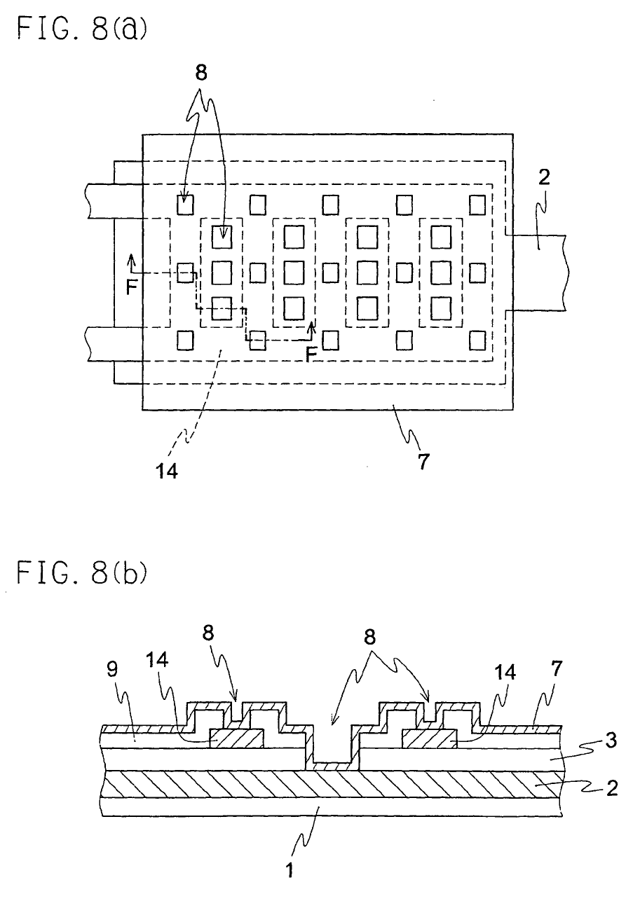

FIGS. 7 and 8 show interconnection between lines at the region near the display area according to Embodiment 5 of the present invention.

FIGS. 7(a) and 8(a) are plan view showing a connection between the gate line 2 and the extended scanning line 14, while FIGS. 7(b) and 8(b) show a cross sectional view taken along line E-E in FIG. 7(a) and line F-F in FIG. 8(a) respectively.

In the above embodiment 1 to 4, the gate line 2 and the extended gate line 14 may be arranged to overlap each other at the converting region (connecting portion) thereof. As shown in FIG. 7, either the gate line 2 or the extended gate line 14 may be formed in a grid like shape. Or, as shown in FIG. 8, formed in a ladder like shape. Thereby, in case where both lines are in different layers interposing a insulating layer, contribution of the resistance of the connecting pattern 7 is reduced to further decrease the contact resistance, so that an array substrate in which delay in scanning signal is reduced can be obtained.

Although the converting region (connecting portion) between the gate line 2 and the extended gate line 14 is show in FIGS. 7 and 8, the same grid like or ladder like shape is applicable for the converting region (connecting portion) between the 15 collected auxiliary capacitance line 13 and the extended auxiliary capacitance lined 15. Contribution of the resistance of the connecting pattern 7 is reduced to further decrease the contact resistance, so that an array substrate in which delay in common signal is reduced can be obtained.

By using an array substrate according to the present embodiment and sandwiching liquid crystal with a counter substrate on which at least a common electrode and a color filter are provided, a display device of superior image, in which unevenness caused by delay in gate signals as well as unevenness caused by delay in common signal are further suppressed, is obtained.

While the present invention is described with the embodiments 1 to 5 in the above, the present invention does not limited to the construction of above embodiments 1 to 5 and various modifications are possible without departing from the scope of the invention. For example, the present invention is not limited to layer construction of the above embodiments 1 to 5 formed on the insulative substrate, and applicable for all display devices in which a gate line (a scanning line) or an auxiliary capacitance line is used for driving.

Moreover, construction of inverted-stagger type (bottom gate type), in which a source and drain electrodes are formed in a upper layer than that of a gate line (scanning line), is described in the above embodiments 1 to 5. However, the present invention is also applicable to construction of stagger type (top gate type), in which a gate line (scanning line) is formed in a upper layer than that of a source and drain electrodes, and the same advantages as those of embodiments 1 to 5 can be obtained.

### INDUSTRIAL APPLICABILITY

The first array substrate according to the present invention comprises a display area in which pixel electrodes are formed, a scanning line arranged between the pixel electrodes, a signal line crossing over the scanning line interposing an insulating layer therebetween, a terminal to which a scanning signal is applied, and an extended scanning line formed from a conductive film for connecting the scanning line, with the terminal, wherein the conductive film for the extended scanning line and that for the scanning line are of different layers. Therefore, increase in contact resistance that arises with the scanning line of Al or Al alloy can be suppressed.

The second array substrate according to the present invention further comprises an auxiliary capacitance line arranged in parallel to the scanning line, a collected it auxiliary capacitance line arranged in parallel to the signal line and electrically connected to the auxiliary capacitance line, a terminal to which a common signal is applied, and an extended auxiliary capacitance line formed from a conductive film for connecting the collected auxiliary capacitance line with the terminal for the common signal, wherein the conductive film for the extended auxiliary capacitance line and that for the collected auxiliary capacitance line are of different layers, in the above first array substrate. Therefore, in an array substrate having auxiliary capacitance, increase in contact resistance that arises with the scanning line, the auxiliary capacitance line and the collected auxiliary capacitance line of Al or Al alloy can be suppressed.

The third array substrate according to the present invention comprises a display area in which pixel electrodes are formed, a scanning line arranged between the pixel electrodes, an auxiliary capacitance line arranged in parallel to the scanning line, a signal line crossing over the scanning line and the auxiliary capacitance line interposing an insulating layer therebetween, a collected auxiliary capacitance line arranged in parallel to the signal line and electrically connected to the auxiliary capacitance line, a terminal to which a common signal is applied, and an extended auxiliary capacitance line formed from a conductive film for connecting the collected auxiliary capacitance line with the terminal, wherein the conductive film for the extended auxiliary capacitance line and that for the collected auxiliary capacitance line are of different layers. Therefore, in an array substrate having auxiliary capacitance, increase in contact resistance that arises with the auxiliary capacitance line and the collected auxiliary capacitance line of Al or Al alloy can be suppressed.

The forth array substrate according to the present invention is characterized in that the extended scanning line and the signal line are formed from the conductive film of same layer in the above first or second array substrate. Therefore, increase in contact resistance that arises with, the scanning line of Al or Al alloy, or with the auxiliary capacitance line and the collected auxiliary capacitance line of Al or Al alloy can be suppressed without increasing, manufacturing steps.

The fifth array substrate according to the present invention is characterized in that the extended scanning line and the pixel electrodes are formed from the conductive film of same layer in the above first or second array substrate. Therefore, increase in contact resistance that arises with the scanning line of Al or Al alloy, or with the auxiliary capacitance line and the collected auxiliary capacitance line of Al or Al alloy can be suppressed without increasing manufacturing steps.

The sixth array substrate according to the present invention is characterized in that the extended scanning line is electrically connected to the scanning line at the neighborhood of the display area and electrically connected to the terminal for the scanning signal at the neighborhood of the terminal in the above forth or fifth array substrate. Therefore, increase in contact resistance that arises with the scanning line of Al or Al alloy, or with the auxiliary capacitance line and the collected auxiliary capacitance line of Al or Al alloy can be suppressed.

The seventh array substrate according to the present invention is characterized in that the extended auxiliary capacitance line and the signal line are formed from the conductive film of same layer in the above second or third array substrate. Therefore, in an array substrate having auxiliary capacitance, increase in contact resistance that arises with the scanning line of Al or Al alloy, or with the auxiliary capacitance line and the collected auxiliary capacitance line of Al or Al alloy can be suppressed without increasing manufacturing steps.

The eighth array substrate according to the present invention is characterized in that the extended auxiliary capacitance line and the pixel electrodes are formed from the conductive film of same layer in the above second or third array substrate. Therefore, in an array substrate having auxiliary capacitance, increase in contact resistance that arises with the scanning line of Al or Al alloy, or with the auxiliary capacitance line and the collected auxiliary capacitance line of Al or Al alloy can be suppressed without increasing manufacturing steps.

The ninth array substrate according to the present invention is characterized in that the extended auxiliary capacitance line is electrically connected to the collected auxiliary capacitance line at the neighborhood of the display area and electrically connected to the terminal for the common signal at the neighborhood of the terminal, in the above seventh or eighth array substrate Therefore, in an array substrate having auxiliary capacitance, increase in contact resistance that arises with the scanning line of Al or Al alloy, or with the auxiliary capacitance line and the collected auxiliary capacitance line of Al or Al alloy can be suppressed.

The tenth array substrate according to the present invention is characterized in that the auxiliary capacitance line, the corrected auxiliary capacitance line and the scanning line are formed from the conductive film of same layer, in any one of the above second to ninth array substrates. Therefore, in an array substrate having auxiliary capacitance, increase in contact resistance that arises with the scanning line of Al or Al alloy, or with the auxiliary capacitance line and the collected auxiliary capacitance line of Al or Al alloy can be suppressed.

The eleventh array substrate according to the present invention is characterized in that the collected auxiliary capacitance line and the extended scanning line are crossing interposing a insulating layer therebetween, in any one of the above second, fourth to tenth array substrates. Therefore, in an array substrate having auxiliary capacitance, increase in contact resistance that arises with the scanning line of Al or Al alloy, or with the auxiliary capacitance line and the collected auxiliary capacitance line of Al or Al alloy can be suppressed.

The twelfth array substrate according to the present invention is characterized in that aluminum or aluminum alloy is used for material of the scanning line, in any one of the above first to eleventh array substrates. Therefore, unevenness in display caused by signal delay in scanning line or unevenness in display caused by delay in common signal is suppressed.

The thirteenth array substrate according to the present invention is characterized in that partly or wholly nitridated aluminum or partly or wholly nitridated aluminum alloy is used for material of the scanning line, in any one of the above first to eleventh array substrates. Therefore, unevenness in display caused by signal delay in scanning line or unevenness in display caused by delay in common signal is further suppressed.

The fourteenth array substrate according to the present invention is characterized in that high melting point metal such as Cr or Mo is used for material of the signal line, in any one of the above first to thirteenth array substrates. Therefore, unevenness in display caused by signal delay in scanning line or unevenness in display caused by delay in common signal is suppressed.

The fifteenth array substrate according to the present invention is characterized in that the scanning line and the extended scanning line are electrically connected via a conductive film of the same layer as that for the pixel electrode, in any one of the above first, second, fourth to fourteenth array substrates. Therefore, unevenness in display caused by signal delay in scanning line or unevenness in display caused by delay in common signal is suppressed without increasing manufacturing steps.

The sixteenth array substrate according to the present invention is characterized in that the collected auxiliary capacitance line and the extended auxiliary capacitance line are electrically connected via a conductive film of the same layer as that for the pixel electrode, in any one of the above second to fifteenth array substrates. Therefore, unevenness in display caused by signal delay in scanning line or unevenness in display caused by delay in common signal is suppressed without increasing manufacturing steps.

The seventeenth array substrate according to the present invention is characterized in that either of the scanning line or the extended scanning line is formed in a grid or ladder like shape at a region in which the scanning line and the extended scanning line are overlapped within a connecting portion between the scanning line and the extended scanning line, in any one of the above first, second, fourth to sixteenth array substrates. Therefore, unevenness in display caused by signal delay in scanning line or unevenness in display caused by delay in common signal is further suppressed.

The eighteenth array substrate according to the present invention is characterized in that either of the collected auxiliary capacitance line or the extended auxiliary capacitance line is formed in a grid or ladder like shape at a region in which the collected auxiliary capacitance line and the extended auxiliary capacitance line are overlapped within a connecting portion between the collected auxiliary capacitance line and the extended auxiliary capacitance line, in any one of the above second to seventeenth array substrates. Therefore, in an array substrate having auxiliary capacitance, unevenness in display caused by signal delay in scanning line or unevenness in display caused by delay in common signal is further suppressed.

The first display device according to the present invention is characterized in that liquid crystal is interposed between any one of the above first to eighteenth array substrate and a counter substrate having a common electrode and a color filter. Therefore, unevenness in display caused by signal delay in scanning line or unevenness in display caused by delay in common signal is further suppressed, so that superior display quality can be obtained.

The first manufacturing method for an array substrate according to the present invention comprises a step of depositing a conductive film and forming a scanning line which is arranged between pixel electrodes, a step of depositing a conductive film of another layer of the scanning line and forming a extended scanning line for connecting the scanning line with a terminal to which scanning signal is applied, and a step of forming a insulating film which is arranged between the scanning line and the extended scanning line and insulates the scanning line from the extended scanning line. Therefore, an array substrate which allows to suppress unevenness in display caused by signal delay in scanning line can be obtained.

The second manufacturing method for an array substrate according to the present invention comprises a step of depositing a conductive film and forming a scanning line arranged between pixel electrodes, an auxiliary capacitance line arranged in parallel to the scanning line and a collected auxiliary capacitance line connected to the auxiliary capacitance line, a step of depositing a conductive, film of another layer of the scanning line, the auxiliary capacitance line and the collected auxiliary capacitance line and forming a extended auxiliary capacitance line for connecting the collected auxiliary capacitance line with a terminal to which common signal is applied, and a step of forming a insulating film which is arranged between the extended auxiliary capacitance line and the scanning line, the auxiliary capacitance line or the extended scanning line and insulates the extended auxiliary capacitance line from the scanning line, the auxiliary capacitance line and the collected auxiliary capacitance line. Therefore, an array substrate which has auxiliary capacitance and allows to suppress unevenness in display caused by delay in common signal can be obtained.

1. An array substrate comprising:
a display area in which pixel electrodes are formed,
a scanning line formed of a low resistivity metal, said scanning line being arranged between the pixel electrodes,
a signal line formed of a high melting point metal selected from the group consisting of chrome, molybdenum, tantalum and alloys thereof, said signal line crossing over the scanning line interposing an insulating layer therebetween,
a first terminal to which a scanning signal is applied,
an extended scanning line formed from a conductive film for connecting the scanning line with the first terminal, said extended scanning line being formed only of the same conductive film as for said signal line,
an auxiliary capacitance line arranged parallel to the scanning line,
a collected auxiliary capacitance line arranged in parallel to the signal line and electrically connected to the auxiliary capacitance line,
a second terminal to which a common signal is applied, and
an extended auxiliary capacitance line for connecting the collected auxiliary capacitance line with the second terminal for the common signal, said extended auxiliary capacitance line being formed only of the same conductive film as for said signal line, wherein the auxiliary capacitance line, the collected auxiliary capacitance line and the scanning line are formed from the conductive film of the same layer.

2. (canceled)

3. An array substrate comprising:
a display area in which pixel electrodes are formed,
a scanning line formed of a low resistivity metal, said scanning line being arranged between the pixel electrodes,
an auxiliary capacitance line arranged in parallel to the scanning line,
a signal line formed of a high melting point metal selected from the group consisting of chrome, molybdenum, tantalum and alloys thereof, said signal line crossing over the scanning line and the auxiliary capacitance line interposing an insulating layer therebetween,
a collected auxiliary capacitance line arranged in parallel to the signal line and electrically connected to the auxiliary capacitance line,
a terminal to which a common signal is applied, and
an extended auxiliary capacitance line formed from a conductive film for connecting the collected auxiliary capacitance line with the terminal, said extended auxiliary capacitance line being formed only of the same conductive film as for said signal line.

4. (canceled)

5. The array substrate of claim 1, wherein the extended scanning line is formed only of a same conductive film for the pixel electrodes, instead of a same conductive film for the signal line.

6. The array substrate of claim 1, wherein the extended scanning line is electrically connected to the scanning line at the neighborhood of the display area and electrically connected to the first terminal for the scanning signal at the neighborhood of the first terminal.

7. (canceled)

8. The array substrate of claim 1, wherein the extended auxiliary capacitance line is formed only of a same conductive film for the and the pixel electrodes, instead of a same conductive film for the signal line.

9. The array substrate of claim 8, wherein the extended auxiliary capacitance line is electrically connected to the collected auxiliary capacitance line at the neighborhood of the display area and electrically connected to the second terminal for the common signal at the neighborhood of the second terminal.

10. (canceled)

11. The array substrate of claim 1, wherein the collected auxiliary capacitance line and the extended scanning line are crossing, interposing an insulating layer therebetween.

12. The array substrate of claim 1, wherein aluminum or aluminum alloy is used for material of the scanning line.

13. The array substrate of claim 1, wherein partly or wholly nitridated aluminum or partly or wholly nitridated aluminum alloy is used for material of the scanning line.

14. (canceled)

15. The array substrate of claim 1, wherein the scanning line and the extended scanning line are electrically connected via a conductive film of the same layer as that for the pixel electrode.

16. The array substrate of claim 1, wherein the collected auxiliary capacitance line and the extended auxiliary capacitance line are electrically connected via a conductive film of the same layer as that for the pixel electrode.

17. The array substrate of claim 1, wherein either of the scanning line or the extended scanning line is formed in a grid or ladder like shape at a region in which the scanning line and the extended scanning line are overlapped within a connecting portion between the scanning line and the extended scanning line.

18. The array substrate of claim 1, wherein either of the collected auxiliary capacitance line or the extended auxiliary capacitance line is formed in a grid or ladder like shape at a region in which the collected auxiliary capacitance line and the extended auxiliary capacitance line are overlapped within a connecting portion between the collected auxiliary capacitance line and the extended auxiliary capacitance line.

19. (canceled)

20. (canceled)

21. (canceled)

22. An array substrate comprising:
a display area in which pixel electrodes are formed,
a scanning line formed of a low resistivity metal, said scanning line being arranged between the pixel electrodes,
a signal line formed of a high melting point metal selected from the group consisting of chrome, molybdenum, tantalum and alloys thereof, said signal line crossing over the scanning line interposing an insulating layer therebetween,
a terminal to which a scanning signal is applied, and
an extended scanning line for connecting the scanning line with the terminal, said extended scanning line being formed only of the same conductive film as for said signal line, wherein either of the scanning line or the extended scanning line is formed in a grid or ladder like shape at a region in which the scanning line and the extended scanning line are overlapped within a connecting portion between the scanning line and the extended scanning line.

23. An array substrate comprising:
a display area in which pixel electrodes are formed,
a scanning line formed of low resistivity metal, said scanning line being arranged between the pixel electrodes,
a signal line formed of high melting point metal selected from the group consisting of chrome, molybdenum, tantalum and alloys thereof, said signal line crossing over the scanning line interposing an insulating layer therebetween,
a terminal to which a scanning signal is applied,
an extended scanning line for connecting the scanning line with the terminal, said extended scanning line being formed only of the same conductive film as for said signal line, and
a connecting portion in which the scanning line and the extended scanning line are overlapped, wherein the connecting portion comprises at least two sets of contact holes, wherein each set of contact holes comprise a first contact hole and a second contact hole for contacting either the scanning line or the extended scanning line, and a third contact hole disposed between the first contact hole and the second contact hole for contacting either of the scanning line or the extended scanning line not contacted by the first contact hole and the second contact hole.

24. An array substrate comprising:
a display area in which pixel electrodes are formed,
a scanning line formed of low resistivity metal, said scanning line being arranged between the pixel electrodes,
an auxiliary capacitance line arranged in parallel to the scanning line,
a signal line formed of a high melting point metal selected from the group consisting of chrome, molybdenum, tantalum and alloys thereof, said signal line crossing over the scanning line and the auxiliary capacitance line interposing an insulating layer therebetween,
a collected auxiliary capacitance line arranged in parallel to the signal line and electrically connected to the auxiliary capacitance line,
a terminal to which a common signal is applied,
an extended auxiliary capacitance line for connecting the collected auxiliary capacitance line with the terminal, said extended auxiliary capacitance line being formed only of the same conductive film as for said signal line, and
a connecting portion in which the collected auxiliary capacitance line and the extended auxiliary capacitance line are overlapped, wherein the connecting portion comprises at least two sets of contact holes,
wherein each set of contact holes comprise a first contact hole and a second contact hole for contacting either the collected auxiliary capacitance line or the extended auxiliary capacitance line, and a third contact hole disposed between the first contact hole and the second contact hole for contacting either of the collected auxiliary capacitance line or the extended auxiliary capacitance line not contacted by the first contact hole and the second contact hole.
